(19) United States
(12) Patent Application Publication
(10) Pub. No.: US 2005/0232512 A1
(43) Pub. Date: Oct. 20, 2005

(54) Neural net based processor for synthetic vision fusion

(75) Inventors: Chiu Hung Luk, Beaverton, OR (US); Daniel W. Hammerstrom, Aloha, OR (US); Misha Pavel, Portland, OR (US); J. Richard Kerr, Tigard, OR (US)

Correspondence Address: Robert D. Varitz;ROBERT D. VARITZ, P.C., 2007 S.E. Grant Street, Portland, OR, 97214, US

(73) Assignees: Max-Viz, Inc.; Oregon Health & Science University

(21) Appl. No.: 10/828,742

(22) Filed: Apr. 20, 2004

(51) Int. Cl. G06K 9/46; G06K 9/36

(52) U.S. Cl. 382/276; 382/190

(57) ABSTRACT

A synthetic vision fused integrated enhanced vision system includes a data base of images of an objective; a non-HVS sensor array for providing a sensor output from each sensor in the array; a feature extraction mechanism for extracting multi-resolution features of an objective and forming a single, fused feature image of the objective; a registration mechanism for comparing the fused feature image to a database of expected features of the objective and for providing registered sensor output vectors; an association engine for processing the registered sensor output vectors with the database of objective images, including an associative match mechanism for comparing the registered sensor output vectors to a data base of objective images and providing comparison vectors therefrom for selecting an objective image for display; and a HVS display for displaying a HVS perceptible image from the data base objective images.

### FIELD OF THE INVENTION

This invention relates to a system and method for enhancing human vision in low-light and obscured conditions, and specifically to a system and method for processing electromagnetic waves through a neural network to produce a HVS perceptible image.

### BACKGROUND OF THE INVENTION

The human visual system (HVS) is not the most sensitive visual system in the animal kingdom. While the HVS may be able to sense color differences in a manner superior to other species, its overall resolution, particularly in low-light conditions, has much to be desired.

There are many techniques and systems which have been used to enhance the HVS, e.g., infra-red imaging, “star-light” imaging systems, radar, etc. These systems rely on a sensor, operating in a specific band of the EM spectrum, an amplifier and a display, which combine to provide a representation of the environment surrounding a human observer. While these systems all have their particular strengths and weaknesses, little has been done to combine the features of these systems into a unitary apparatus to aid human vision.

Initial Rationale for Enhanced Vision

The basic rationale for Enhanced Vision Systems (EVS) on fixed and rotary wing aircraft is increased safety in the form of “enhanced situation awareness” derived from infrared (IR) imagery. This applies at night and/or in obscurants, such as haze, smog, and many fog scenarios. The significance of improved vision when flying at night is quite substantial and should not be underestimated. In addition to weather-limited visibility, haze over the national airshed has become a frequent and continent-spanning issue, further reducing visibility.

Utilization of EVS addresses such critical areas as runway incursions; controlled flight into terrain (CFIT) avoidance; general safety enhancements during approach, landing, and takeoff; and ground operations. It is however a potentially significant, autonomous asset for use at Cat I and non-precision fields, as well as for random navigation operations. Safety statistics are increasingly dominated by human vs equipment failure, and it is highly probable that a number of CFIT and incursion-related accidents in recent years could have been avoided with the availability of basic EVS.

Traditionally, the industry has looked for a direct economic payback for investment in such a capability. However, with the very attractive cost/performance and reliability attributes of the newest EVS technology, operators are realizing the advantages of “autonomous safety enhancement” in their own right.

It is desirable to provide a system which will display the environment to a human observer, regardless of light, weather and visual obscuration elements, in order that the human observer may be aware of, and interact with, the surrounding environment. Although a principle use for the invention is in aircraft, the system is also useful for any situation where a human observer's vision is restricted by conditions in the environment.

A general approach of “separate-thread,” sensor-based integrity assurance has been pursued for more than a decade—including in the context of the Boeing “Enhanced Situational Awareness System (ESAS),” Harrah et al., The NASA Approach to Realize a Sensor Enhanced Synthetic Vision System (SE-SVS), Proceedings of the 21 st Digital Avionics Systems Conference, IEEE CH37325 (2002).

Baseline EVS Sensors

The search for baseline IR imagers, optimally tailored to EVS, has lead to a new generation of non-cryogenically-cooled, microbolometer focal plane arrays, Tiana et al., Multispectral uncooled infrared enhanced-vision systemforflight test, Proc. SPIE: Enhanced and Synthetic Vision 2001, Vol. 4363, pp. 231-236 (2001); Kerr et al., New infrared and systems technology for enhanced vision systems, Max-Viz, Inc., public release (2002); NATO/RTA/SET Workshop on Enhanced and Synthetic Vision Systems, RTO-MP-107, Ottawa, Ontario (2002). A reason for development of these imagers is that EVS requires a wide-field-of-view, which implies short-focal-length optics. The low-f number required to achieve high performance with “uncooled” imagers may be achieved using small and inexpensive lenses, having a typical aperture diameter of about 1.5 inches. The absence of a cryocooler contributes greatly to reliability, compactness, lightweight, and low-cost imaging units. With such “fast” optics, sensitivities may be comparable to those of cryocooled detectors. Ongoing defense-based development has a specific goal of approaching theoretical (thermal-fluctuation-limited) performance, Murphy et al., High-sensitivity 25 μm microbolometer FPAs, Proc. SPIE: Infrared Detectors and Focal Plane Arrays VII, Vol. 4721, pp. 99-110 (2002). Uncooled sensors are virtually “instant-on,” which provides quick system initialization.

A further advantage of these imagers is that they operate in the long-wave infrared (LWIR) spectrum, typically 8-14 microns. Conversely, cryocooled sensors utilized for EVS operate at mid-wave infrared (MWIR, 3-5 microns). Infrared often provides a significant fog-penetrating capability, and because of the higher wavelength/droplet size ratio, LWIR has generally superior performance in such scenarios, Kerr et al., supra. Furthermore, in the cold ambient conditions that are most challenging for infrared EVS, the background scene energy is shifted to LWIR and uncooled sensitivity can actually be superior to that of cryocooled MWIR, Kerr et al., supra. In fact, the only advantages for MWIR over LWIR are in such non-EVS applications as (1) surveillance/reconnaissance requiring long-focal-length telescopes, and (2) very-long propagation paths having a high gaseous water content (humid, maritime atmosphere), which is absorptive to LWIR.

The LWIR or MWIR alternatives are utilized to image the thermal background scene, including en route terrain, runway boundaries, airport features, structures, incursions/obstacles, and traffic. In addition, it is highly desirable to enhance the acquisition of runway/approach lighting. Cryocooled MWIR units are typically extended down to short-wave IR (SWIR) wavelengths to accomplish this. However, the dynamic range problem inherent in the simultaneously handling of high-flux lights and low-flux thermal backgrounds tends to compromise both functions.

With uncooled LWIR, it is preferable to add a second, uncooled short-wave infrared (SWIR) imager, operating generally in a 0.9-1.6 micron range, and provide separate processing of the LWIR/SWIR signals. Optical and electronic filtering permits the extraction of the lights of interest, including stroboscopic lighting, while rejecting much of the clutter of extraneous lighting in the scene; these lights are overlayed onto the general, e.g., thermal, scene. The LWIR and SWIR units may, however, utilize a common aperture. The extraction and fusion operations for this dual-uncooled sensor approach are accomplished in a field-programmable gate array (FPGA)-based processor. U.S. Pat. No. 6,232,602 B1 granted May 15, 2001, and U.S. Pat. No. 6,373,055 B1 granted Apr. 16, 2002, to Kerr for Enhanced vision system sensitive to infrared radiation.

### SUMMARY OF THE INVENTION

A synthetic vision fused integrated enhanced vision system includes a data base of images of an objective stored in a memory; a non-HVS sensor array for providing a sensor output from each sensor in the array; a feature extraction mechanism for extracting multi-resolution features of an objective, and for forming a single, fused feature image of the objective the sensor outputs; a registration mechanism for comparing the extracted fused, feature image to a database of expected features of the objective and for providing registered sensor output vectors; an association engine for processing the registered sensor output vectors with the database of objective images; including an associative match mechanism for comparing the registered sensor output vectors to said data base of images of the objective, and providing comparison vectors therefrom for selecting an objective image for display; and a HVS display for displaying a HVS perceptible image from the data base objective images.

A method of forming a synthetically fused image includes detecting an objective with a sensor array; providing a sensor output from each sensor in the sensor array and providing a data base of objective images; extracting features of the objective from each sensor output; forming a single, fused feature image from the extracted features of each sensor output; registering the extracted features with known features of the objective to provide registered sensor output vectors; processing the registered sensor output vectors in an association engine to locate an objective image of the objective in the data base of objective images; and displaying a HVS perceptible image from the objective image data base.

It is an object of the invention to provide an aid for the human visual system which will render the environment visible regardless of environmental obstructions through synthetic vision fusion.

Another object of the invention is to provide notice of objects moving through an environment to a human observer.

A further object of the invention is to provide a method and system to aid aircraft operations.

Another object of the system and method of the invention is fabrication and deployment of a cockpit system which includes situation awareness enhancement and integrity monitoring for random navigation/required navigation performance operations, and economically achieves instrument meteorological conditions (IMC) operations.

A further object of the invention is to provide information to a pilot or auto-pilot for landing in zero-zero visibility conditions, at non-precision equipped airfields, including primitive landing areas.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of an EVS.

FIG. 2 is a block diagram depicting a SVF IEVS constructed according to the invention to provide a synthetic image.

### DETAILED DESCRIPTION OF THE PREFERRED EMBODIMENTS

Commercial and military (dual-use), autonomous Cat III (700 feet visual range at ground level) operations may be achieved through the proper integration of enhanced visual systems (EVS) with global positioning system (GPS) Landing Systems/Flight Management Systems (GLS/FMS). Other relevant avionics include inertial sensors, enhanced ground-proximity warning systems (EGPWS), automatic dependence surveillance—broadcast (ADS-B), and traffic alert and avoidance system (TCAS), collectively referred to herein as an “integrated enhanced vision system, or IEVS. The system and method of the invention disclosed herein is an IEVS which provides synthetic vision fusion (SVF) using a neural-network-driven association engine.

A challenge facing the developers of IEVS is that random navigation/required navigation performance approvals are evolving towards Cat I minima (1800 feet visual range at 200 feet altitude above the runway), and potentially lower minima for certain military transport missions, while the requirement for still lower decision heights occurs in generally less than one percent of operations. Therefore, any added capability must be highly cost effective in terms of both system cost, including the expense for added avionics, and actual integration of the IEVS into an aircraft.

As previously noted, the SVF IEVS system and method of the invention is suitable for use in any situation where the human visual system (HVS) is obstructed by environmental conditions, however, the invention is best explained in the context of an aircraft system. The ultimate role of an IEVS includes presenting sensor imagery to a user on a head-up display and/or head-down display (HUD/HDD). All-weather, multi-sensor image data is combined and used to verify on-board database imagery, e.g., the user interface, which may take the form of sparse or iconic displays, which are optimized from a human factors standpoint, i.e., “fusion of enhanced and synthetic vision.” The EVS-based data is also utilized in machine interfaces, using EVS/database correlation to generate separate-thread navigation, attitude, and hazard signals for verification against conventional navigation, e.g., GPS/inertial navigation system (INS), and stored map/terrain data.

A use of the system and method of the invention is fabrication and deployment of a cockpit system which includes situation awareness enhancement and integrity monitoring for random navigation/required navigation performance operations, and economically achieves instrument meteorological conditions (IMC) operations, ultimately to zero-zero visibility conditions, at non-precision equipped airfields, including primitive landing areas, in the case of military operations. A key aspect to achieving regulatory approval of IEVS in these roles is proof of system integrity, including real-time, automated confidence monitoring; and adequate back-up provisions for situations where such monitoring indicates inadequate integrity.

The computer processing operations for this SVF invention are computationally intense. Neural-net-derived technology, in the preferred embodiment, is used to achieve these capabilities in an economical and compact platform, and to provide clear, transparent confidence metrics. A particular feature of this approach is that it is robust in the presence of degraded image data, including noise and obscurations.

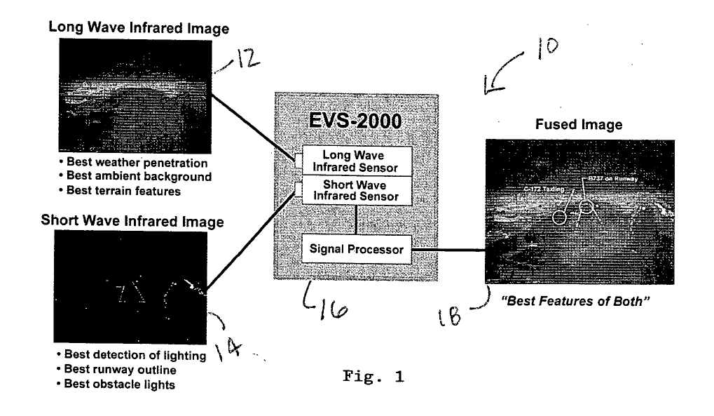

The operation of a rudimentary EVS having dual sensors, is illustrated in FIG. 1, generally at 10, EVS 10 includes an LWIR sensor (8-14 microns) 12, a SWIR sensor (0.9-1.6 microns) 14, processing circuitry 16 and a fused image 18. Fused image 18 depicts a night-time approach to an airport. Other embodiments of the invention may include MWIR sensors. Note the B737 on the far end of the runway and the C172 on the taxiway.

All-Weather Sensor Suite

Notwithstanding the high sensitivities which are now available, LWIR is not always effective in fog conditions. A choice to complement the baseline EVS sensors is imaging millimeter wave (MMW) radar. The MMW penetrates fog quite well, but has limited resolution. An image-fusion system may be used to seamlessly “flesh-out” the composite image as the IR emerges during a landing approach, as is done in the SVF IEVS of the invention. As discussed later herein, however, direct display may not represent the optimum utilization of these assets in an EVS.

Imaging MMW continues to progress in performance, physical size, and cost. The wavelength band (propagation window) of choice for EVS is 94 GHz, although 140 GHz shows increasing promise for better size/angular resolution while offering satisfactory atmospheric transmission. A major remaining barrier to the use of 140 GHz is its cost.

Basic diffraction (antenna) physics limit the “true” angular resolution of a 94 GHz system to 1.1 degrees per 10 cm of antenna cross-section, based on a half-Rayleigh criterion, however, in order to actually realize this resolution, sufficient over-sampling is required. In addition, depending upon the robustness of the signal-to-noise ratio, a degree of super-resolution may also be achieved.

The most common configuration for active MMW “imagery” is to use mechanical or electronic scanning in azimuth, along with range resolution from processing of the frequency modulated continuous wave (FMCW) return. The resultant plan-position indicator (PPI), or “B-scope,” presentation is then converted to a pseudo-perspective, i.e., C-scope, display. However, such substitution of range resolution for elevation resolution results in artifacts that have proven objectionable to many users. Nevertheless, it has been shown that this type of sensor can very effectively derive ground-correlated navigation and hazard detection, Kom et al., Navigation Integrity Monitoring and Obstacle Detection for Enhanced Vision Systems, Proc. SPIE: Enhanced and Synthetic Vision 2001, Vol. 4363, pp. 51-57 (2001).

Covert operators have generally preferred passive systems, or, at least prefer active systems with constrained emissions. Passive systems tend to be true, azimuth/elevation resolving, “cameras,” which primarily sense differing MMW scene reflections from the cold, sky background. Sensitivity vs update rate, and physical size vs resolution, have traditionally been issues with passive MMW cameras.

The demands of military users for advanced, autonomous landing and terrain following/terrain avoidance (TFTA) capabilities require true, three-dimensional active MMW imagers. This introduces a range parameter into the hazard-recognition function. The achievement of simultaneous resolution in azimuth, elevation and range is challenging, both for FMCW and pulsed systems. Current investigations encompass antenna/installation requirements and overall system tradeoffs; it appears that this challenge can be met, albeit at a higher cost level than is envisioned for a general-purpose, commercial EVS unit.

Ultimately, two solutions with differing priorities may be offered: (1) lowest cost: an affordable sensor suite for “all-weather situation awareness,” and (2) highest performance and integrity, for IEVS operation under Cat III conditions.

EVS Processing and Integration

Standard image processing functions for EVS include non-uniformity correction, auto-gain and level (preferably on a local-area basis), and other enhancements. This is followed by fusion of the signals from a multi-imager sensor suite.

Enhancements include feature extraction and object recognition for runway and hazard detection, and the inclusion of ground-map correlation in order to generate sensor-based navigation and hazard alert signals, Kom et al., supra; and Le Guilloux et al., Using imaging sensors for navigation and guidance of aerial vehicles, Proc. SPIE: Sensing, Imaging and Vision for Control and Guidance of Aerospace Vehicles, Vol. 2220, pp. 157-168 (1994). These enhancements provide powerful options in IEVS, including pilot and machine interfaces, as discussed later herein.

The above functions may be achieved using hardware ranging from standard PCs to digital signal processing (DSP) to field-programmable gate array (FPGA) and processor boards to bulky, specialized platforms. The most powerful algorithms must be implemented on cost effective, compact, “productized” hardware encompassing software and firmware design rules that are compliant with stringent certification requirements for IMC operations.

There are a number of steps in the method of the invention: the first step is feature extraction, wherein the environment is viewed by the sensors and converted into appropriate digital “images”—viewable to the processing system, but likely of little direct value to the HVS, as a single, fused feature image. The second step is matching the fused, extracted feature image to a database of the known environment to determine location of the sensors, and hence, the aircraft, referred to herein as registration or normalization. The third step is processing of the normalized feature image to determine best match and, via an exact match operation on the best match result, to a stored database of images, which stored images may be displayed to a user in HVS form. A final, optional, step is the correlation of the fused feature images with stored images and designation of non-usual activity, which may constitute a hazard.

Association Engine Approach—Overview

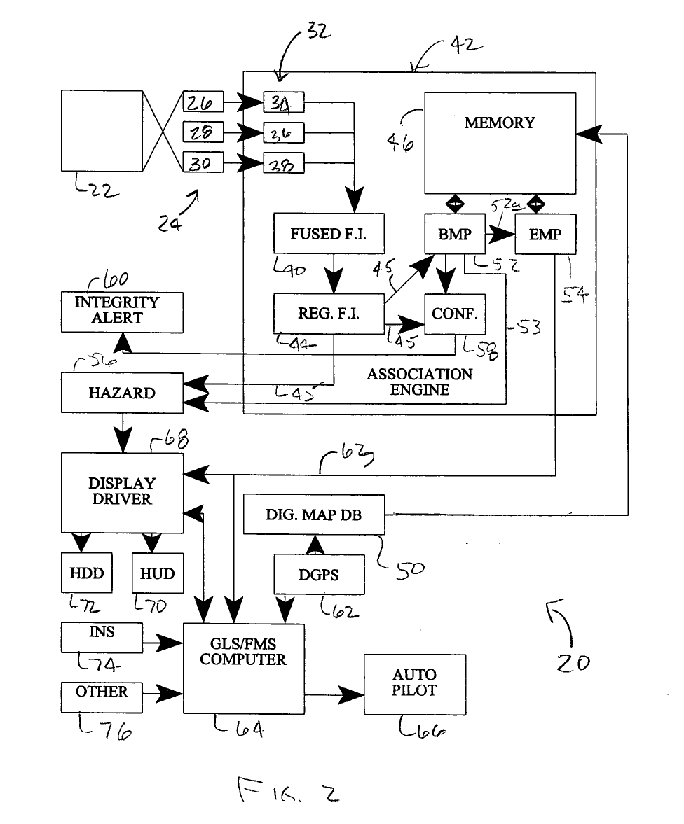

Referring to FIG. 2, a synthetic vision fusion integrated enhanced vision system (SVF IEVS) constructed according to the invention is depicted generally at 20. An IMC obscured destination 22, an objective, is depicted, and detected by a sensor array 24, having a LWIR sensor 26, a SWIR sensor 28, and a MMW sensor 30. LWIR and SWIR sensors built by FLIR Systems, Inc. are suitable for incorporation into the system of the invention. MMW sensors may be secured from known manufacturers. In some instances, a MWIR sensor may be included in array 24. Sensor outputs from each sensor in the sensor array are directed into a feature extraction mechanism 32, which extracts multi-resolution features from sensors 26, 28 and 30 with feature extractors 34, 36, and 38, respectively.

Each image is processed through feature extractor mechanism 32. Each feature image, or feature vector, has some competitive shaping, which acts as a noise filter. This operation is performed by doing a K-Winners-Take-All (K-WTA) operation, where the K largest values are left intact, and the remaining vector elements are set to zero. The feature vectors are then added together by simple vector addition to get a single, fused feature-vector, or single, fused feature image, and thresholding via a second K-WTA operation is performed. The value of K here is smaller than for the first K-WTA operations, and, in this operation, the winning vector elements are set to “one,” while the losing vector elements are set to “zero.” If the image has Nₓ*N_{y} pixels, the corresponding vector has M×N nodes, of which only a fixed K (typically hundreds of nodes) are 1's. As depicted in FIG. 2, feature extraction mechanism 32 is part of an association engine (AE) 42, which, in the preferred embodiment, is a neural network, although the system of the invention may be implemented using one or more separate processors for feature extraction.

Feature extraction is initially performed by feature extraction mechanism 32, using a V1 emulation, then an AE operates on the fused feature image. The V1 feature extraction involves the extraction of image features from each electronic visual system (EVS) sensor, in a “biologically inspired” manner that emulates aspects of the primate visual pathway, Rolls et al., Computational Neuroscience of Vision, Oxford University Press (2001); and Field, What is the Goal of Sensory Coding?, Sejnowski, Ed., Unsupervised Learning, Cambridge, Mass., MIT Press, pp. 101-143 (1999). In its most basic form, this is a form of edge extraction, which generally corresponds to “V1” cells in the human visual cortex.

Higher levels of abstraction may also be advantageous. Thus, other V1 visual layers may iterate this process, which is roughly comparable to visual areas V2, V4, etc. In such a hierarchical approach, as a consequence, at each level, the number of features decreases since they are incrementally becoming higher-level abstractions. The feature space begins to inherently tolerate variations in the image, e.g., translation, rotation, and scale, and the number of active features and amount of clutter are reduced. It can in fact be shown from a theoretical perspective that these kinds of feature detections capture and pass on the most significant information; Rolls et al., and Field, supra.

Each sensor generates a video image, possibly at differing resolutions. All images are converted to the same resolution and frame rate. The sensors are “registered” physically to one another so that they all “see” the same objective. Usually, some image processing is done on the raw video output, typically a kind of low-pass spatial filtering to reduce noise in each image. At this point there are three nearly identical images which, in low visibility conditions will have different kinds of noise and occlusion.

AE Memory

AE 42 receives and stores local EVS multi-sensor features and local SVS visible imagery and position data in an AE memory 46, which includes two groups of data associated with each objective, e.g., a specific approach path to a specific runway at a specific airfield. The first group contains the weight vectors of best match processor (BMP) 52, and the second is a data base which is referenced via an exact match processor (EMP) 54 upon receipt of output from best match processor 52. BMP 52 and EMP 54 comprise what is referred to herein an associative match mechanism. The first memory is a set of binary weights derived algorithmically from training vectors and depends on the registration and feature extraction algorithms used. The second memory is the data base of runway approaches which is created at system initialization. As used in connection with aircraft operations, each approach to a runway is referred to herein as an objective.

Training Vectors

The system and method of the invention requires a set of training vectors to create the weights for BMP 52. In the preferred embodiment, a set of training vectors is created for every approach an aircraft is expected to use. During system development, the training vectors are used to generate the weight matrices, one for each objective, for BMP 52. Training vectors are also generated for the database for EMP 54. Training vectors are generated from a digital map database 50, and a mass storage database of EVS multi-sensor image features, SVS visible imagery and positional indexing in memory 46. These training vectors are most likely generated via a flight simulator, or by flying multiple, clear-weather approaches. When an aircraft is landing in clear, high visibility circumstances, the fused feature image which is generated by the feature extraction mechanism is stored into AE memory 46 as a training vector, or “template” vector, to be re-called during system operation, i.e., comparison of the actual fused feature image to the stored “ideal” versions of the fused feature image. Once BMP 52 returns the best match ideal vector 52a, a hash operation, i.e., exact match association, is performed by EMP 54 to generate the index that points to a data base entry that corresponds to the best match training vector. Each data base entry has additional information, such as aircraft position and a display image (for HUD/HDD).

In practice, it is also necessary to correct for misregistration of the real-time imagery with the reference database. Although this can be achieved through conventional processing, it is also an ideal application for another, ancillary AE, which is not used in the preferred embodiment described herein. In this case, the engine may be trained on generic runway images as a function of perspective; the best match output is indexed with respect to aircraft attitude and offset. This approach promises to be robust in the presence of translation, rotation, scaling, and distortion; and it will reduce the number and varieties of training sessions required by the AE.

Fused feature image 40 is sent to a registration mechanism 44, which returns a set of coordinates that tell the system how far the runway image is off from the center of the image. Internal avionics on the aircraft may provide roll pitch angle, referred to herein as rotation. The registration process “normalizes” the image by placing it into the center of the field of view. The fused feature image is adjusted accordingly and the resulting “normalized” feature image, referred to herein as a registered sensor output, or a registered sensor output vector, 45, is the processed by BMP 52, which performs a computationally efficient comparison of the normalized feature image input with all the training images which were used to generate the weight matrix stored in the memory. The AE returns the feature-vector, from the training set, which is the closest match, in Hamming or bit distance, to the input vector. This return functions as a comparison vector. The comparison vector is input to EMP 54, which generates a pointer to an objective image stored in AE memory 46, which is then displayed.

Hazard Detection

A hazard detection mechanism 56 determines the presence of potential hazards, i.e., anomalies in the data visible to the sensors. These anomalies are determined by subtracting the input feature image from the final BMP 52 output feature image. The AE looks for consistent localized differences to determine the presence of a potential hazard, by performing an image subtraction. If the difference image is reasonably localized, rather than spread randomly throughout the image, a hazard is signaled. Hazard detection occurs by taking the original fused feature vector and doing an image subtract with the output of the AE, which is one of the original feature images, to compare the normalized feature image to the best-match output to monitor for obstacles, e.g., incursions, ground vehicles, animals, and other obstructions not represented in the database. By subtracting the BMP 52 output 53 from the BMP input, i.e., registered feature image 44 signal, a registered sensor output vector 45, in hazard detection mechanism 56, and processing for systematic, multiple-frame, discrepancies in this difference vector, the system can see such hazards with a high degree of sensitivity, where a hazard is defined as any difference between the stored image and the real image. Furthermore these differences are not diffuse but are localized. Even then the difference may not necessarily be due to a real hazard but any discrepancy (atmospheric occlusion, aircraft on the taxiway, water droplets on the sensors, etc. Consequently, the difference is highlighted for the pilot, but is not necessarily announced as a major hazard.

Through indexing of the best match, multi-sensor reference vector, along with inversion of the registration operation on the displayed images and highlighting of the differential (input minus best match) hazard vector, AE 42 outputs the correct visual image along with navigation, attitude and hazard signals.

Integrity Alert

The real-time metric of best-match quality, combined with discrepancy (hazard) annunciation, constitutes an integrity monitor 60 for the SVF IEVS with its correlation processor, also referred to herein as a confidence monitor, 58, and the database itself. Significantly, the instantaneous database imagery that is invoked by the system is not tied to, i.e., indexed by, any conventional navigation system, such as a GPS/INS. Hence this integrity thread is independent of any conventional navigation system. This is a significant contrast to conventional, navigation-triggered synthetic vision systems.

Integrated Architecture

Under the control of DGPS 62, the regional, forward-view database, i.e., imagery and associated navigation parameters, are, before commencement of a particular approach, loaded into AE memory 46. It is again important to note that the connection between the DGPS/navigation system and the database is second-order only: as long as the applicable locale is loaded, the SVF IEVS display and EVS-navigation outputs are derived autonomously.

EVS navigation signal 63 constitutes a “machine interface” output from EMP 54. At this point, there are very different conceptual alternatives for operating the aircraft, and human factor considerations are intensely involved. Specifically, if the operational philosophy is autopilot based, the pilot display data are used simply as an integrity monitor, and signal 63 is provided to a GLS/FMS computer 64, which drives auto-pilot 66. Alternatively, if it is pilot-in-loop based, predictive guidance information is given to the pilot through a display driver 68, which drives a HUD 70 or HDD 72, using conventional HUD guidance system (HGS) symbology, “Goalpost” or “tunnel in the sky” cues. To complete description of SVF IEVS 20, DGPS data 62 is provided to GLS/FMS computer 64. DGPS data control the database in the sense of performing a download of information to AE 42, for the geographic region in which the aircraft is located. INS data 74 and data from other systems 76 are also provided to computer 64.

Therefore, pilot interface issues, as described above, are actually a subset of a much broader concept: the direct use of the SVF IEVS signal in a FMS interface. Also, the SVF IEVS becomes a pilot interface option, rather than an operational philosophy.

Now that the system of the invention has been presented in overview, the system and method of the invention will be described in greater detail.

Sensor Image Capture

The sensors typically capture a 320×240 pixel image. Thermal background objective 22 is detected by uncooled, LWIR imager 26, while the runway/approach lights are derived from SWIR imager 28, which is optimized for that purpose. Both IR sensors are able to penetrate darkness. MMW imager 30 is able to penetrate obscurations, such as atmospheric water in liquid form, e.g., fog or low clouds, while infrared is able to penetrate fine particulate matter, e.g., smog, dust, etc., detecting terrain background, however, a pure MMW image is likely meaningless to the HVS. After some filtering, the noisy sensor images undergo edge-like-feature (VI) extraction in multi-resolution feature extraction mechanism 32, which representation is then registered 44 and input to BMP 52 and confidence measure 58. BMP 52 output vector calls up a database image for display. These operations are highly robust in the presence of sensor noise, and partial image obscuration, as may occur with clouds or fog, in the infrared case.

AE-Based Integrity

Sensor images are processed during feature extraction, which, in the preferred embodiment, uses a visual cortex (V1) extraction algorithm, and which, for this particular application, is a convolution with Gabor filters, and may further be enhanced by the use of multiple layer feature extraction. The filter output for each node is then optionally passed through a non-linear flnction. Then, the entire vector for each sensor is passed through the K-WTA. K is the number of all non-zero entries allowed in a vector, and is generally significantly smaller that the vector N (Nₓ*N_{y}) dimension. A convolution and Gabor filtration process defines a pixel of interest and a surrounding number of pixels, e.g., 3×3 field, 9×9 field, etc., known as a “receptive field,” and performs a 2D convolution on the receptive field to generate a new pixel in the place of the pixel of interest. This process reduces noise, and combines temporal and frequency domains, thus finding a compromise between temporal and frequency representations. The result is a localized feature of a certain spatial frequency range at an approximate position. Generally image transitions, such as edges, are highlighted by such a filter. In the preferred embodiment of the method of the invention, a single layer is used, however, the process could use multiple layers, that then would be similar to V2, V3, etc., in primate visual cortex, to further refine edge definition, though location resolution is lost, which may be a problem for BMP 52 if taken too far, because many images begin to look alike.

The resulting feature resolution of a feature image (FI) is generally lower than the sensor input, and, in the preferred embodiment, is a 128×128 pixel image. Lowering the resolution requires less mathematical processing, and such subsampling of the image reduces noise. The lower resolution also reduces the memory requirement in the feature extraction mechanism. The lower resolution further induces some translation invariance.

The conversion to a feature image puts all the images into a common feature vector space across sensor modalities, e.g., one edge is the same as any other edge, or, and edge is an edge is an edge, although some edges are more visible to some sensors than to others. Once the image is normalized in feature space, the images are fused by vector addition, and processed through a K-WTA filtering function.

Registration, or normalization, which is dynamic and occurs with each image, in a single, dynamic registration step, may be accomplished in either of two methods: (1) all possible environmental images, e.g., runway images for designated landing sites, may be stored in a database for comparison with the extracted feature images; or (2) only normalized (canonical) variations are stored in a database for comparison with the extracted feature images, which requires normalization of feature images before comparison with the database images. The second method is used in the preferred embodiment described herein.

The next step is a comparison, in the sense that BMP 52 find the best match between the input and the stored (training) images, i.e., between the feature images and the database images, takes place in AE 42. The comparison uses the inner product of the weight matrix and the input vector. Then a K-WTA function is applied to the result of the inner product, where V1 is the input vector, W is the weight matrix, and Vₛᵤₘ is the result of the vector matrix inner product:
W×Vᵢ=Vₛᵤₘ (1)
and
Vₒᵤₜ=f_{K-WTA}(Vₛᵤₘ) (2)
Again, two methods are available. The association engine may be used as hetero-association, i.e., input and output spaces are different, or auto-association, i.e., input and output spaces are the same. Auto-association allows the output to be fed back to the input for several iterations. Thus Vₒᵤₜ is the same as Vᵢₙ, along the constraints of the generalized AE model.

To generate a weight matrix, W, normalized training vectors combined (all sensors) feature obtained from clear meteorological images for a specific runway, and a specific approach to that runway. Such training may be done off-line, e.g., as in a flight simulator. A variation of this method is adaptive real-time training, e.g., fly the approach in clear meteorological conditions and land the aircraft a few times. Either way, the resulting weight matrix is portable between systems and aircraft, and may be created (1) in real-time during an actual approach, (2) in a simulator containing a simulated approach to the actual runway, or (3) for an abstract, generic runway. Each approach to a runway will have a different weight matrix, Another technique, used when the specific approach is not stored in the database, is to use a weight matrix derived from artificial runway data, e.g. Jeppesen® data. A weight matrix is generated for each training vector. These are then OR'd together to compute the final weight matrix. The weight matrix is defined by taking the outer product of each training vector with itself, and then performing a bit-wise OR of each training vector matrix. The operation of the memory is such that an input vector is considered to be a noisy version of a training vector:

$$\begin{matrix}{\overline{w}}_{ij} = {{⋃}_{μ = 1}}^{M} {{x}_{i}^{μ} ( {y}_{j}^{μ} )}^{T} & ( 3 ) \\ {V}_{in} -> K - WTA -> {V}_{out} & ( 4 ) \\ {V}_{w} = {V}_{train} + {V}_{noise} & ( 5 ) \\ {V}_{out} = {V}_{train} + {V}_{noise} & ( 6 ) \\ where & \\ {V}_{noise} < {V}_{train} , and {V}_{noise} could = 0 & ( 7 )\end{matrix}$$

The operation of the system assumes that each actual input vector is a training vector with noise added. The operation of the AE is such that the noise is filtered out and the original training vector recovered.

After two or three iterations through BMP 52, BMP 52 returns the Vₘᵢₙ which is closest to Vᵢₙ. This operation may be approximated, in the preferred embodiment, as generating a Voronoi Tessellation (VT) of the vector space, which is a division of the space into regions surrounding each training vector. When a vector is input to an associative memory, the training vector returned, ideally, is the training vector that is closest, in terms of the Hamming distance, i.e., the number of bits they have which are different. Such a classification function is said to create a Voronoi Tessellation. As used herein, a system which implements a VT approximates Baysian Classification (BC), using certain error assumptions, by returning the most “probable” training vector. The algorithm (Palm) used by BMP 52 approximates VT, but not precisely, which approximates BC, thus, the BMP approximates a BC.

However, if Vₙₒᵢₛₑ is too large, and/or the regions used in the VT (Voronoi Regions -VR) are too small, the AE can match Vᵢₙ, to the wrong Vₜᵣₐᵢₙ, which can occur when the training vectors are too close to one another or when there are too many training vectors. Assume a constrained vision problem: i.e., all runways essentially look alike, therefore, all Vₜᵣₐᵢₙ look alike, and VRs are all very small. This leads to a situation where the AE is likely to err in matching vectors. One way to correct this problem is to use a temporally enhanced feature image (TEFI):
TEFI=FI+Δ(current FI+previous FI) (8)
That is, the feature image (FI) is augmented with differential information from the previous feature image, which adds features to enlarge the VRs, thus pushing the training vectors apart, and increasing the accuracy of the recall process matching Vᵢₙ to Vₜᵣₐᵢₙ. The recall process may require several iterations of comparing/matching Vᵢₙ to Vₜᵣₐᵢₙ e.g., two or three iterations being typical. This leads to the question of when are sufficient iterations performed. The memory is said to have stabilized when the output stops changing, i.e., when Vᵢₙ≦Vₒᵤₜ, or Vᵢₙ(T)=V(T−1).

For each input feature image, it is important to determine if the feature images is too noisy for the BMP to find the correct training vector. This is done using a heuristic technique, where the informational entropy (H) is used as an estimate of uncertainty.
ΣVₛᵤₘ(i) (9)
where i indexes each individual element in a vector.

$$\begin{matrix}Pi = \frac{{V}_{sum} ( i )}{N} & ( 10 ) \\ H = \sum Pi log Pi ( first order entropy ) & ( 11 )\end{matrix}$$

H has a maximum value when all values of Pi are equal; H is zero when only one possibility remains
H=Σ log(1)=0 (12)
Referring back to the definition of K in K-WTA,
K−log₂n (13)
where n is a vector or weight matrix dimension. As the matrices used herein are generally sparse, sparse matrix handling techniques may be used in the AE.

Self-organizing, associative networks, or association engines (AE), based on probabilistic models offer a significant computational advantage, as opposed to more traditional techniques for doing basic computer vision processing, especially for the level of object recognition used by fusion algorithms. These networks may be implemented using economical reconfigurable FPGAs or DSPs.

Complex biological elements have been added to traditional association models with excellent results. Given a probabilistic learning rule, association models using “distributed representations” are, in some ways, supersets of Bayesian networks, Jensen, Bayesian Networks and Decision Diagrams, New York, Springer, (2001).

Association Memory

Associative memory is a pervasive operation in complex forms in a variety of neural circuitry. Briefly, associative memory stores mappings of specific input representations to specific output representations, and performs recall from an incomplete, or noisy, input. Unlike conventional memory, data are stored in overlapping, distributed representations: the sparse, distributed data representation leads to generalization and fault tolerance. The associative memory accomplishes a very efficient implementation of “best match” association.

Best Match Processing

Best-match association is useful in a wide variety of applications, however, it is computationally intensive. There are no known “fast,” for example, such as the equivalent of Fast Fourier Transforms (FFTs) implementations. Best-match association also seems to be something that is commonly performed by neural circuitry. In fact, it appears that variants on this primary “canonical” computation are performed by most neural circuitry. There have been a number of associative memory structures proposed over the years which use parallel, neural like implementations, Palm et al., Neural Associative Memories, C. Weems, Ed., Associative Processing and Processors, Los Alamitos, Calif., IEEE Computer Society, pp. 307-326 (1997); Palm et al., Associative Data Storage and Retrieval in Neural Networks, Domany et al., Eds., Models of Neural Networks III, New York, Springer, pp. 79-118 (1996); Palm, On Associative Memory, Biological Cybernetics, Vol. 36, Heidelberg, Springer-Verlag, pp. 19-31 (1980); and Willshaw, et al., Improving Recall from an Associative Memory, Biological Cybernetics, Vol. 72, Heidelberg, Springer-Verlag, pp. 337-346 (1995); but there are few known fully functional commercial products based on best-match association.

There are a number of technical problems which are required to be solved in creating a functioning best-match associative memory system in a real-time application. But first, one must be able to formally describe the operation of such a memory. For the system and method of the invention, it is assumed that the Voronoi Tessellation is the ideal computational model of the associative memory functionality. From there it may be shown that the distributed representation associative memories approximate VT. Given that a VT can be shown to perform a Bayesian inference under certain conditions makes it an appropriate model for best-match associative processing.

Another issue is to create an efficient associative memory model which approximates Bayesian inference. A feature of the invention is to provide an associative memory which approximates Bayesian association in real-time over very large data sets.

The best match function described herein may also be implemented using a brute force approach, where a simple processor is associated with each training vector in the memory, or some small group of training vectors, wherein the match is computed in parallel, followed by a competitive “run-off” to see which training vector has the best score. Though hardware intensive, this implementation of best match guarantees favorable results and can easily be used to generate optimal performance criteria, however, its computer requirements make it too slow for most real-time applications.

Image Representation

Assume for the moment that a database imagery set is available for the aircraft route and destination area of interest. This may be obtained for example from dedicated flight data; or from National Imagery and Mapping Agency (NIMA) and Digital Elevation Model (DEM) data, with appropriate transformations both for basic cockpit perspective and for the physics of the individual sensors. Such a transformation may also involve non-perspective imagery, such as the case of an azimuth-range MMW sensor. Each reference image is indexed for its navigational position, and associated with the basic visual image from which it is derived. Salient-feature extraction is performed on the multi-imager reference imagery, thereby generating “training vectors.” The outer product of a complete (regional) set of such vectors generates a binary weight matrix that constitutes the BMP memory for that set. This constitutes “training” of the BMP, which in this case can be accomplished by compilation from a database library of binary feature data. This assumes “naive priors,” i.e., equal probabilities over the training vectors.

In operation, the inner product of the weight matrix with an arbitrary (real time, degraded) input feature vector yields a sum vector. A non-linear K-WTA filter operation is then performed on the sum vectors to generate the output vector. Using a suitable metric, the BMP determines the best match, in feature space, between this output vector and the training vectors. The final output is the chosen training vector, which is indexed with respect to its associated, visual training image as well as its navigational position. BMP 52 then recalls the feature vector, which is approximately the Bayesian Maximum Likelihood, or best-match, (ML) ground-correlated scene.

Each image's features are represented in the form of long, but sparse binary vectors, with thresholds set such that the number of “active nodes” (binary ones) is the same for every vector. Thus, in effect, for any given sensor and image, this scheme automatically lowers the threshold until a given number of salient features are captured. The vectors from multiple sensors—such as infrared 26, 28, and MMW 30—are then combined by simple vector addition, to achieve a “fused,” composite input vector to the AE for each fused video frame 40. This composite, normalized vector is input to BMP 52, which produces an output vector, which is, in turn, input to EMP 54, which produces a pointer to the database of images, and a selected image may then be shown on a HDD/HUD. The approach currently uses “naive priors,” where each image is assumed to be equally likely. This is a reasonable assumption for the method of the invention. In the case of auto-pilot operations, the selection of an objective image provides a digital signal position indication, e.g., distance, attitude, heading, etc., to GLS/FMS computer 64, which sends guidance signals to auto-pilot 66.

Associative Memory and Operation

The associative memory algorithm stores mappings of specific input representations to specific output representations xᵢ, such that xᵢ→yᵢ. The network is constructed via the input-output training set (xᵢ, yᵢ), where F(xᵢ)=yᵢ. The mapping F is approximative, or interpolative, in the sense that F(xᵢ+ε)=yᵢ+δ, where xᵢ+ε is an input pattern that is close to a training vector x^{μ} being stored in the network, and δ=ε with δ→0. This definition also requires that a metric exists over both the input and output spaces.

Using a simplified “auto-association” version of Palm's generic model, where the input and output spaces are identical, makes it easier to do several passes of the input vector through the associative memory, because the output can be fed back as input. Furthermore, all vectors and weights are binary valued (0 or 1), and of dimension N. There is also a binary valued n by n matrix that contains the weights. Output computation is a two-step process:

1) an intermediate sum is computed for each of the N nodes:

$${s}_{j} = {\sum }_{i}^{N} {w}_{ji} {x}_{I} \qquad ( 14 )$$

In the notation, a vector x is input; and an inner product is computed between the elements of the input vector and each row,j, of the weight matrix. For auto-association the weight matrix is square and symmetric.

2) the node outputs then are computed:
ŷⱼ=ƒ(sⱼ−θⱼ) (15)

The function, ƒ(x), is a step function: it is 1 if x>0 and 0 if x≦0, leading to a threshold function whose output ŷ, is 1 or 0, depending on the value of the node's threshold, θⱼ. The setting of the threshold is discussed below. In Palm's basic model, there is one global threshold, but more complex network models relax that assumption.

The next important aspect of these networks is that they are “trained” on M vectors to create the weight matrix W. The weights are set according to an outer-product rule. That is, the matrix is computed by taking the outer product of each training vector with itself, and then doing a bit-wise OR of each training vector's weight matrix, according to Eq. 3.

The final important characteristic is that only a fixed number, K, of nodes are “1,” or “active,” for any vector. The number of active nodes is set so that it is a relatively small number compared to the dimensions of the vector itself; specifically, Palm suggests K=O(log N). This also creates a more effective computing structure.

A K-WTA operation is performed on the result of the matrix vector multiply, where a global threshold value, θ, which is the same for all nodes, is adjusted to insure that only the K nodes with the largest sums are 1. This is known as “K winners-take-all” (K-WTA).

Palm has also shown that at maximum memory capacity, the number of 1s and 0s in the weight matrix should be balanced; that is, p₁=p₀=0.5. For Mtraining vectors with K=log₂(N), this occurs at an optimal capacity of roughly 0.69 information bit per physical bit (synapse).

Practical Operation of the AE

In the most straightforward embodiment of a ground-correlated EVS, there also exists an on-board database of digital imagery for each approach the aircraft may make. These data may be provided from airborne surveillance with actual sensors under ideal conditions, however, it is more likely that they are simplified images which are derived from sensor-physics-based transformations of visible image databases, e.g., derived from the National Imagery and Mapping Agency (NIMA). Such resources are commercially available, Conference Proceedings, Database availability and characterization, NATO/RTA/SET Workshop on Enhanced and Synthetic Vision Systems, supra, and ultimately need to be applied to the environs of all landing fields of interest.

In the AE approach, each sensor's image is fused, normalized, and added together to generate a fused, normalized image. For training runs, these vectors are not stored explicitly, but rather, are used to generate the weight matrix. This is highly efficient: a relatively simple processing board can download multi-sensor video data for, e.g., an hour's flying time, from a standard mass storage device. Downloading this matrix may be likened to an instantaneous “training” of the associative memory. In addition, each database vector is “tagged” or indexed with its geographical location, for later use as an EVS-navigation signal; and may also be indexed with its associated visual image.

The AE memory structure thus includes a weight matrix derived via the output product operation performed over the training vectors for a particular approach. In operation, the AE processor compares this memory with a real-time vector input for each video frame, and converges on a “best match” stored vector as the output. This approximates a Bayesian Maximum Likelihood (BML) operation, which is the statistically appropriate means of correlating real-time imagery with the database, as shown by Sharma et al, Bayesian sensor imagefusion using local linear generative models, Soc. of Photo-Optical Engineering Instrumentation, vol. 40, SPIE, pp. 1364-1376 (2001).

Now consider any given output vector, which comprises a BML database match to the multi-sensor signal for that video frame. In a post-processing step, including a simple exact match, or “hashing,” operation on the output of BMP 52, the associated visual image data and position parameters may be retrieved. Such visual data may be utilized in a synthetic vision display, and the position constitutes an instantaneous EVS-navigation signal. The visual image data storage requirement is limited by the sparse or iconic synthetic-vision rendering scheme that is being utilized.

Spatial and Temporal Multi-resolution

Added operations which increase the robustness and/or add to efficiency of the AE include spatial multi-resolution, Burt, A Gradient Pyramid Basis for Pattern-Selective Image Fusion, Society for Information Display International Symposium Digest, vol. 23, Society for Information Display, pp. 467-470 (1992), and multiple-frame correlations. The latter is accomplished in a manner that does not introduce latency or smearing of dynamic details. The latter may be done using a “three dimensional (x,y,t)” Gabor filter, Sharma et al, supra.

Image Registration

A very important aspect of ground-data correlation of image sensors is that of registration, carried out in registration mechanism 44. Through the implementation of required geometric transformations in the processor, including rotation, translation, and scaling, the scope of the stored database for correlation is minimized. In addition, by continuously measuring these image operations, additional estimates of attitude and lateral position with respect to the landing approach path are generated.

Confidence Metrics

The very high integrity requirements of EVS require that there be some measure of memory confidence in the output. There may be a large distance (in feature space) between the returned vector and the nearest training vector. In many cases, the AE may need to iterate several times, typically three to four, to converge on a reference. However, if the input images are sufficiently noisy, even after several iterations, the best match may conceivably “not make sense” (false correlation), in the sense that the wrong training vector or even a spurious (false) output is obtained. For example if the feature vector from the sensors has so much noise that it is in the VR of a different vector, than that vector will be chosen as BMP output.

Error tolerance and retrieval confidence also relate to the number of training vectors used to generate the weight matrix for BMP 52. Currently, storage systems store roughly about 70% to 80% as many training vectors in a memory as there are nodes (vector dimensional), without any degradation in the recalled image. As an example, for a 320×240=76.8K feature nodes, about 60K images, or more than a half hour of reference video, may be stored at 30 fps, without capacity-limited recall. The storage capacity may be lower if the training vectors are very close to one another in vector space. In practice, full temporal and spatial resolution of the ground data is not required, except for the aircraft's destination area; therefore the requirements for reloading the AE from a master on-board database are quite reasonable.

The AE concept offers effective mechanisms for continuous confidence measuring of the “quality” of ground-truth correlation. This occurs through comparison of each instantaneous input (feature representation) vector with the BML output. Such comparison may utilize a simple Euclidean distance measure, in high-dimensional vector space, between the vectors; the number of disagreeing bits or “Hamming distance”; or a more sophisticated heuristic involving vector entropy. In the latter, equally weighted features suggest randomness, or high entropy, and therefore low confidence.

Database Issues

A destination-region database required for the above operations is available to most users. This includes sufficient breadth and detail to apply to random navigation/required navigation performance, as well as non-standard landing approaches. The appropriate detail is flight phase dependent, which is key to limiting the required on-board memory capacities to levels that are readily achieved with today's technology, including PC-based. The positional resolution of the stored imagery becomes much greater during landing approach, with the greatest detail occurring near threshold, e.g., the display detail increases with ground proximity. For commercial use, high resolution inserts of airport environs may be appropriate. Terrain and obstacle data requirements are treated in RTCA/DO-276.

Implementation of the AE: Simulation and Emulation

A key element of certification of the SVF IEVS system of the invention is the ability to simulate these algorithms to understand their dynamic behavior and their sensitivity to implementation variations, limited precision, etc. Zhu et al., Simulation of Associative Neural Networks, International Conference on Neural Information Processing, Singapore (2002), and the inventors hereof have developed a neural network simulation environment at the Oregon Graduate Institute (OGI), Csim (Connectionist SIMulator). Csim is object oriented and is written in C++. It uses objects that represent groups, clusters, or “vectors” of model nodes. It can operate on parallel clusters and uses the Message Passing Interface (MPI) for interprocess communication. A set of associative network models operate on this unit. Csim is optimized for data storage and inner loop operation.

Hardware Implementation

The real-time hardware implementation of the SVF IEVS of the invention includes the following: (1) significant computation is required for the VI feature extraction. This is especially true when three-dimensional (spatial/temporal) multi-resolution and/or multi-layer feature extraction are used; (2) the associative weight memories required for this application have extremely large dimensions, e.g. a 128×128 image has a vector dimension of 16,384×16,384 (1282), and a 16,384×16,384 weight matrix. Although bit-level encoding and the use of sparse matrix techniques reduces storage requirements and total compute time; (3) execution of these algorithms requires the ability to fetch long arrays directly from memory; (4) such computation presents problems for state-of-the-art processors, which, notwithstanding very high clock rates, are constrained by memory bandwidth; (5) while caching helps, not all programs make efficient uses of caches, which is particularly true of programs which have little reference locality; and (6) these programs have significant parallelism which may be leveraged by FPGA implementation.

There are a number of ways to emulate very large associative networks, from high-speed microprocessors to DSP to FPGAs. The most likely basic building block for this capability is a specialized, FPGA-based accelerator board. It has been shown, e.g., Platform Performance Comparison of PALM Networks on a Pentium® 4 and FPGA, Gao, et al., IJCNN03, July 2003, that FPGAs are highly efficient at processing the algorithms described herein. These components are steadily moving into mainline digital signal processing, and though operating at lower frequencies than state of the art microprocessors, FPGAs offer significant parallelism for those computational models which utilize them. The associative models, as well as many of the other algorithms used herein, map very efficiently to FPGAs.

The key to being able to sustain the high rate of computation required by these applications is to build a system with balanced input/output and computation. Amdahl's law states that a system is only as fast as its slowest component. For the systems used herein, the most difficult aspect is to guarantee sufficient bandwidth from the input sensors to the system memory. In addition, the number of operations per element and the number of elements determine the memory bandwidth requirements. Because of the need to spill to off-chip memory, many compute-intensive kernel tasks are severely limited by the memory bandwidth available in a single conventional processor. General-purpose processors, such as PCs and servers, have a processor-memory bottleneck.

Even though the FPGA runs at a slower clock rate, which is due to the extra hardware required for reconfiguration, when the computations are highly parallel and have low fixed point precision, the FPGA may easily consume and utilize data at its highest bandwidth rates.

SVF IEVS

It is generally agreed in the industry that, for the foreseeable future, DGPS-based navigafion/landing guidance systems (GLS) will have insufficient integrity for all-weather operations, because such systems do not account for inherent GPS integrity lapses, hazards such as mobile obstacles, discrepancies or obsolescence in the database. The ultimate evolution of IEVS will occur within the context of optimally integrated avionics suites, seamlessly incorporating such subsystems as DGPS, INS, EGPWS, ADS-B, TCAS, and on-board databases.

The ultimate outputs available from the AE-based EVS processor are as follows:

Machine Interface

The SVF IEVS generates separate-thread navigation, attitude and hazard signals. In the FMS, the navigation and attitude may be compared with GLS, as well as inertial 74 and other avionics 76 inputs. This is a generalization of a “terrain match navigator,” and suggests that—in the complete IEVS—the “highest and best use” of the imagery and its associated data may not be in the form of pilot displays, but rather, through the FMS machine interface.

When the AE processor is used, relatively displeasing imagery, such as that from the MMW sensor, particularly if not vertically resolved, is utilized only to help generate the correct, clean visual display from the database. In fact, with this emphasis on machine use of the data, the pilot may also be buffered from such interpretive workloads, even if conventional EVS-navigation processing is used, Korn et al., supra.

Pilot Interface

Based upon the best match and exact match output, or on conventional processing, a visual image may be presented either head-down 72 or on a conformal, stroke-raster HUD 70. There exists considerable ongoing work in the human factors area, regarding the best implementation of this interface, NATO/RTA/SET Workshop on Enhanced and Synthetic Vision Systems, supra. Alternatives include photo-realistic imagery, sparse, e.g., wire frame, or symbolic imagery. In essence, such an AE/correlation driven display constitutes “sensor-verified synthetic vision.” The goal is to permit the pilot to readily interpret the image data, symbology, and, in the HUD case, real world cues without interference and undo clutter. Also, attention must readily be drawn to critical data elements, such as potential hazard alerts. A possible added tool is the use of color, noting that, traditionally, the color red is reserved for hazard indications.

The image data may be utilized in either of two ways: (1) as an integrity monitor for autopilot operation; or (2) with guidance symbology, e.g., a predictive “highway in the sky.” An infrared sensor does not present a wholly realistic image from a human factors standpoint, and a millimeter wave image presents an even less HVS interpretable image. The AE provides the ability to reproduce a purely visual image, even in the case where, e.g., the instantaneously useful sensor input to the processor is only that of the millimeter wave unit. Thus, input image fusion is used from a system integrity standpoint, and is readily translatable to the final system output in human visual terms.

The pilot interface output from the AE is thus visual-based imagery that probably utilizes a synthetically fused scene rendering, but is nevertheless real-time-sensor verified. In addition, a hazard cue or more detailed hazard characterization, is added. These collectively serve as a direct pilot's integrity monitor, for either autopilot operation or direct flight guidance.

Integrity of the Overall IEVS

With the establishment of quantitative confidence metrics in the AE subsystem, a final, important step is to establish the overall-system failure mechanisms and probabilities, to achieve an “extremely improbable” (10⁻⁹) failure level appropriate for Cat III (700 foot visible range at ground level) operations.

The SVF IEVS of the invention is applicable to other fields of endeavor, including, but not limited to, image and face recognition, as might be used in security systems, and in medical imaging.

Thus, a neural synthetic vision fusion has been disclosed. It will be appreciated that further variations and modifications thereof may be made within the scope of the invention as defined in the appended claims.

1 A synthetic vision fused integrated enhanced vision system, comprising:
a data base of images of an objective stored in a memory;
a non-HVS sensor array for providing a sensor output from each sensor in the array;
a feature extraction mechanism for extracting multi-resolution features of an objective, and for forming a single, fused feature image of the objective the sensor outputs;
a registration mechanism for comparing the extracted fused, feature image to a database of expected features of the objective and for providing registered sensor output vectors;
an association engine for processing the registered sensor output vectors with the database of objective images; including an associative match mechanism for comparing the registered sensor output vectors to said data base of images of the objective, and providing comparison vectors therefrom for selecting an objective image for display; and
a HVS display for displaying a HVS perceptible image from the data base objective images.

2. The system of claim 1 wherein said sensor array includes a LWIR sensor, a SWIR sensor and a MMW sensor.

3. The system of claim 1 wherein the single, fused feature image is formed by vector addition of sensor outputs.

4. The system of claim 1 wherein said feature extraction mechanism includes V1 feature detection and K-WTA processing.

5. The system of claim 1 wherein said associative match mechanism includes a best match mechanism.

6. The system of claim 1 wherein said associative match mechanism includes an exact match mechanism.

7. The system of claim 6 wherein said HVS display displays an image of an objective from said database, and wherein a comparison vector points to an image of an objective in said database after said exact match mechanism locates an exact match between a fused feature image and an image of an objective in said database.

8. The system of claim 7 wherein the input for said exact match mechanism is output from a best match mechanism.

9. The system of claim 1 wherein the registration mechanism normalizes a feature image of the objective across sensor modalities.

10. The system of claim 1 which approximates the operation of a Voronoi classifier for training the association engine with an enhanced feature image.

11. The system of claim 1 which includes a hazard detection mechanism for comparing the registered sensor output vector to a best match comparison of the output vector to the objective image database to identify possible incursion of the objective by a hazardous entity.

12. The system of claim 1 which includes a confidence monitor using entropy as a heuristic measure of system integrity.

13. A method of forming a synthetically fused image comprising:
detecting an objective with a sensor array;
providing a sensor output from each sensor in the sensor array and providing a data base of objective images;
extracting features of the objective from each sensor output;
forming a single, fused feature image from the extracted features of each sensor output;
registering the extracted features with known features of the objective to provide registered sensor output vectors;
processing the registered sensor output vectors in an association engine to locate an objective image of the objective in the data base of objective images; and
displaying a HVS perceptible image from the objective image data base.

14. The method of claim 13 wherein said detecting includes providing a sensor array having a LWIR sensor, a SWIR sensor and a MMW sensor.

15. The method of claim 13 wherein said registering includes normalizing a feature image of the objective across sensor modalities.

16. The method of claim 13 wherein said association engine performs a Voronoi classification for training the association engine with an enhanced feature image.

17. The method of claim 13 wherein said extracting features includes V1-like feature extraction using a K-WTA protocol.

18. The method of claim 13 wherein said registering the extracted features with known features of the objective to provide registered sensor output vectors includes comparing extracted features with known features of a generic representation of a class of similar objectives.

19. The method of claim 13 wherein said processing the registered sensor output vectors in an association engine includes processing by a neural network.

20. The method of claim 13 which includes processing using edge extraction.

21. The method of claim 13 which includes processing by a Palm association engine process.

22. The method of claim 13 wherein said forming a single, fused feature image includes forming a fused feature image by adding vectors of extracted vectors.

23. The method of claim 13 wherein said processing includes a best match comparison between the registered sensor output vector and the data base of objective images.

24. The method of claim 23 which further includes detecting hazards by comparing the registered sensor output vectors to the best match comparison to identify possible incursion of the objective by a hazardous entity.

25. The method of claim 13 wherein said processing includes an exact match comparison between the registered sensor output vector and the data base of objective images, and generating a pointer from the exact match comparison.

26. The method of claim 25 wherein said displaying includes displaying an image selected from the database of objective images as indicated by the pointer.

27. The method of claim 25 wherein said exact match comparison includes using a registered sensor output vector as an input to a best match comparison, and using the best match output vector as the exact match input.
